(19) United States
(12) Patent Application Publication
(10) Pub. No.: US 2026/0291043 A1
(43) Pub. Date: Sep. 24, 2026

(54) METHOD AND APPARATUS FOR REMOVING FLUID FROM BATTERY CASE

(71) Applicant: SAMSUNG SDI CO., LTD., Yongin-si (KR)

(72) Inventors: Seunghoon Kim, Yongin-si (KR); Hyun Kim, Yongin-si (KR); Kyosong Koo, Yongin-si (KR)

(73) Assignee: SAMSUNG SDI CO., LTD., Yongin-si (KR)

(21) Appl. No.: 19/329,937

(22) Filed: Sep. 16, 2025

(30) Foreign Application Priority Data
Mar. 18, 2025 (KR) 10-2025-0034623

(51) Int. Cl. H01M 50/691; H01M 10/48; H01M 50/342

(52) U.S. Cl. CPC H01M 50/691; H01M 10/48; H01M 50/3425

(57) ABSTRACT

Provided are a method and apparatus for removing a fluid from a battery case. The method of removing a fluid from a battery case includes generating pressure information by measuring a pressure of the battery case by using at least one pressure sensor provided in the battery case, determining whether a preset condition is satisfied, based on the pressure information, and forming a fluid discharge port in the battery case by controlling a through unit based on a result of the determining.

### CROSS-REFERENCE TO RELATED APPLICATIONS

This present application claims priority to and the benefit under 35 U.S.C. § 119(a)-(d) of Korean Patent Application No. 10-2025-0034623, filed on Mar. 18, 2025, in the Korean Intellectual Property Office, the entire disclosure of which is incorporated herein by reference.

### FIELD

The present disclosure relates to a method and apparatus for removing a fluid from a battery case.

### BACKGROUND

Secondary batteries are rechargeable, unlike primary batteries that are not rechargeable but dischargeable. Low-capacity secondary batteries are used in compact portable electronic devices such as smartphones, feature phones, laptop computers, digital cameras, and camcorders, and large-capacity secondary batteries are widely used as power sources for driving motors in hybrid cars, electric cars, and as power storage batteries. These secondary batteries include an electrode assembly including a positive electrode and a negative electrode, a case for accommodating the electrode assembly, and an electrode terminal connected to the electrode assembly.

Meanwhile, secondary batteries may experience swelling during the charging and discharging process, which may cause gas to be generated inside the case, causing the case to swell. This may lead to ignition and explosion, so various technologies are being developed to control the pressure inside the case. According to the related art, the pressure inside the case is controlled by providing a vent on the case, but there is a problem in that the vent cannot be controlled from the outside and that the vent may not break even when the internal gas needs to be discharged.

The background technology described herein is technical information that the inventor possessed for deriving the present disclosure or acquired in the process of deriving the present disclosure, and cannot necessarily be considered as publicly known technology disclosed to the general public prior to the application for the present disclosure.

### SUMMARY

The present disclosure provides a method and apparatus for removing a fluid from a battery case. The objectives to be achieved by the present disclosure are not limited to those mentioned herein, and other objectives and advantages of the present disclosure that are not mentioned may be understood by the following description and will be more clearly understood by the embodiments of the present disclosure. In addition, it will be appreciated that the objectives to be solved by the present disclosure and advantages of the present disclosure may be realized by the means and combinations thereof indicated in the patent claims.

According to aspects of the present disclosure, there is provided a method of removing a fluid from a battery case, the method including generating pressure information by measuring a pressure of the battery case by using at least one pressure sensor provided in the battery case, determining whether a preset condition is satisfied, based on the pressure information, and forming a fluid discharge port in the battery case by controlling a through unit based on a result of the determining.

According to aspects of the present disclosure, there is provided a fluid removing apparatus for removing a fluid, the fluid removing apparatus including a battery case accommodating a battery cell, a through unit forming a fluid discharge port in the battery case, and a controller controlling the through unit, wherein the controller generates pressure information by measuring a pressure of the battery case by using at least one pressure sensor provided in the battery case, determines whether a preset condition is satisfied, based on the pressure information, and forms a fluid discharge port in the battery case by controlling the through unit based on a result of the determining.

According to aspects of the present disclosure, there is provided a computer-readable recording medium having recorded thereon a program for causing the method described herein to execute on a computer.

Other aspects, features and advantages other than those described herein will become apparent from the following drawings, claims and detailed description of the present disclosure.

### BRIEF DESCRIPTION OF THE DRAWINGS

The following drawings attached to this specification are intended to illustrate at least embodiments according to the present disclosure, and together with the detailed description of the present disclosure described herein, serve to further understand the technical idea of the present disclosure, and therefore, the present disclosure should not be interpreted as being limited only to the matters described in the drawings.

FIG. 1 is a diagram schematically illustrating a fluid removing apparatus according to embodiments;

FIG. 2 is a diagram for describing a battery case and a pressure sensor, according to embodiments;

FIG. 3 is a diagram for describing a battery case and a pressure sensor of embodiments;

FIG. 4 is a diagram for describing a through unit according to embodiments;

FIG. 5 is a diagram for describing a process of forming a fluid discharge port in a battery case, according to embodiments;

FIGS. 6 and 7 are graphs for describing a preset condition according to embodiments;

FIG. 8 illustrates an example of an operating method of a fluid removing apparatus, according to embodiments; and

FIG. 9 is a block diagram of a controller according to embodiments.

### DETAILED DESCRIPTION

The advantages and features of the present disclosure and methods of achieving the advantages and features will be described more fully with reference to the embodiments described in detail together with the accompanying drawings. However, the present disclosure is not limited to the embodiments presented herein, but may be implemented in various different forms, and should be understood to include all changes, equivalents, and substitutes that do not depart from the spirit and technical scope of the present disclosure are encompassed in the present disclosure. The embodiments set forth herein are provided to make the present disclosure complete and to fully convey the scope of the present disclosure to those skilled in the art to which the present disclosure pertains. In explaining the present disclosure, if it is determined that a detailed description of a related known technology may obscure the gist of the present disclosure, the detailed description will be omitted.

The terminology used herein is for the purpose of describing particular embodiments only and is not intended to limit the present disclosure. Unless otherwise defined, all terms used herein have the same meaning as commonly understood by one of ordinary skill in the art to which the present disclosure belongs.

In this specification, singular expressions include plural expressions unless the context clearly indicates otherwise. Furthermore, it should be understood that terms such as “include” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Additionally, terms including ordinal numbers, such as “first” or “second,” used herein may be used to describe various components, but the components should not be limited by the terms. Terms are used solely to distinguish one component from another.

The expressions such as “in embodiments,” “according to an embodiment,” “relating to an embodiment,” or “according to an implementation of an embodiment” in this specification are not necessarily all referring to the same embodiment. Additionally, throughout the specification, the term “embodiment” is an arbitrary distinction used to facilitate the description of the present disclosure, and each embodiment is not necessarily exclusive of the others. For example, configurations mentioned for the purpose of describing an embodiment may be applied and/or implemented in other embodiments, and may be applied and/or implemented with modifications without departing from the scope of the present disclosure.

Some embodiments of the present disclosure may be represented by functional block configurations and various processing steps. Some or all of these functional blocks may be implemented with any number of hardware and/or software configurations that perform specific functions. For example, the functional blocks of the present disclosure may be implemented by one or more microprocessors or by circuit configurations for a given function.

For example, the functional blocks of the present disclosure can be implemented in various programming or scripting languages. Functional blocks may be implemented as algorithms that run on one or more processors. Additionally, the present disclosure may employ conventional techniques for electronic environment setting, signal processing, and/or data processing. Terms such as “mechanism,” “element,” “means,” and “composition” may be used broadly and are not limited to mechanical and physical configurations. Additionally, terms such as “-unit”, “-module”, etc. mean a unit that processes at least one function or operation, which may be implemented by hardware or software, or a combination of hardware and software.

Additionally, the connecting lines or connecting members between components illustrated in the drawings are only illustrative of functional connections and/or physical or circuit connections. In an actual device, connections between components may be represented by a variety of alternative or additional functional, physical, or circuit connections.

Additionally, some components in the drawings may be illustrated with somewhat exaggerated size or proportions. Additionally, components illustrated in one drawing may not be illustrated in another drawing.

The present disclosure will be described in detail with reference to the attached drawings herein.

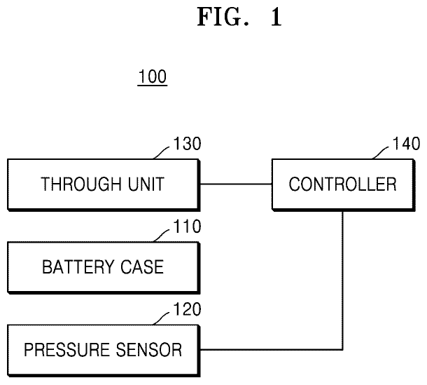

FIG. 1 is a drawing schematically illustrating a fluid removing apparatus according to embodiments.

Referring to FIG. 1, a fluid removing apparatus 100 according to embodiments may include at least one battery case 110, at least one pressure sensor 120 corresponding to the battery case 110, a through unit 130 corresponding to the battery case 110, and a controller 140.

In the present disclosure, the fluid removing apparatus 100 refers to an apparatus that is integrated into a power supply system including a battery, so as to discharge fluid from a battery case when necessary for safe operation of the battery. In embodiments, the power supply system may be implemented as, but is not limited to, a battery-powered electric vehicle (EV), hybrid electric vehicle (HEV), electric bicycle (E-Bike), power tool, energy storage system (ESS), uninterruptible power supply (UPS), portable computer, portable telephone, portable audio device, and/or portable video device.

In embodiments, the fluid removing apparatus 100 may include the battery case 110. The fluid removing apparatus 100 may discharge a fluid (e.g., gas and/or liquid) generated inside the battery case 110 out of the battery case 110.

In embodiments, the battery case 110 may accommodate any one battery cell among a plurality of battery cells constituting a battery pack. A battery pack according to embodiments may be configured to include a plurality of battery cells. A battery pack may be provided as a single package and may be understood as a collection of a plurality of distinguishable electrode assemblies.

A battery cell according to embodiments may include a secondary battery cell that is rechargeable. For example, a battery cell may include an electrode assembly including a cathode material, an anode material, an electrolyte, and a separator of a battery. The battery cell may be implemented as a square, cylindrical, or pouch-shaped cell according to the assembly form, but is not limited thereto.

The battery case 110 may accommodate at least one battery cell. For example, the battery case 110 may include an outer wall having a shape such as a rectangular parallelepiped or a cylinder, and may have an inner space to accommodate at least one battery cell. A single battery case 110 may accommodate a single electrode assembly, i.e., a single battery cell, or may accommodate a plurality of distinguishable electrode assemblies, i.e., a plurality of battery cells.

In embodiments, the battery case 110 may include a conductive metal such as, but not limited to, aluminum, an aluminum alloy, or nickel-plated steel.

The battery case 110 may expand. This is known as battery swelling. For example, an electrolyte (e.g., lithium-ion electrolyte, etc.) of a battery cell accommodated in the battery case 110 may vaporize and pressure inside the battery case 110 may increase, thereby causing the battery case 110 to expand. The battery case 110 may include an elastic material (e.g., metal, etc.) so as not to explode even under increased internal pressure and to be able to recover its shape when the internal pressure stabilizes.

In embodiments, the battery case 110 may have a vent. For example, the battery case 110 may have at least one vent in at least one surface forming the battery case 110. As an example, the battery case 110 may have a vent on a top cover forming an upper portion of the battery case 110 and/or a bottom cover forming a lower portion of the battery case 110.

The vent provided in the battery case 110 may be ruptured when the internal pressure of the battery case 110 exceeds a certain rupture pressure, thereby discharging the fluid (e.g., vaporized electrolyte, etc.) inside the battery case 110 out of the battery case 110. However, the vent that ruptures due to internal pressure may not be controllable from the outside. The rupture pressure needs to be set low to ensure stability of fluid discharge, but if the rupture pressure is designed to be too low, the vent may rupture even in unnecessary situations due to overcharging or high-temperature storage. On the other hand, if the rupture pressure is designed to be excessively high, the vent may not rupture even though the battery cell accommodated in the battery case 110 is in an abnormal state, which may result in an accident such as thermal runaway.

According to embodiments, the fluid removing apparatus 100 may further include the controller 140, the pressure sensor 120 that is used to measure pressure in the battery case 110 by the controller 140, and the through unit 130 that forms a fluid discharge port in the battery case 110 by the controller 140.

In embodiments, the controller 140 may include a battery management system (BMS) that monitors and controls the condition of a battery. In embodiments, the BMS may optimize the performance, safety, and lifespan of the battery by monitoring and controlling the condition of the battery. In embodiments, the BMS may monitor the voltage, current, and/or temperature of the battery. Additionally, the BMS may detect abnormal battery conditions such as overcharge, overdischarge, overcurrent, and/or overheating.

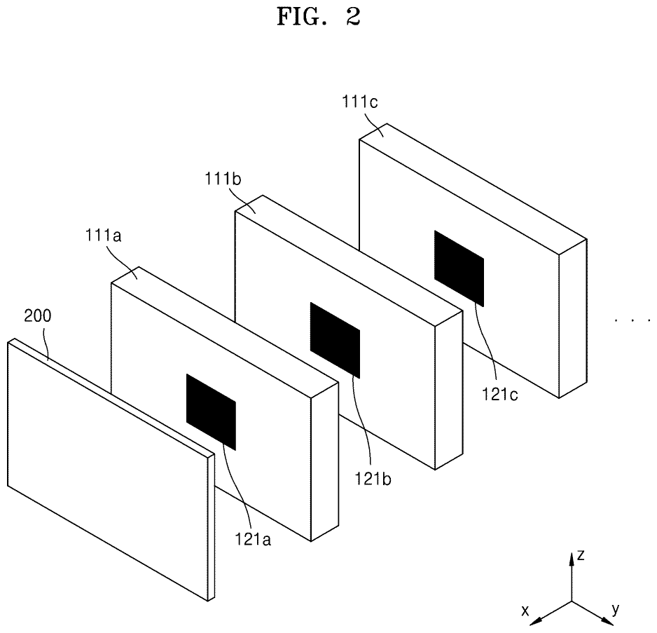

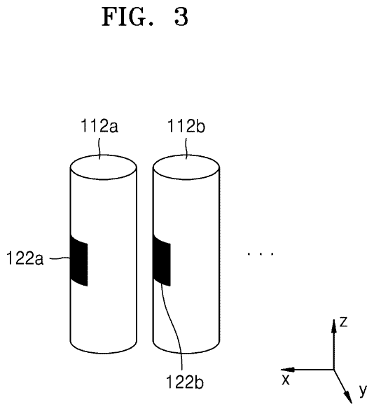

In embodiments, the controller 140 may generate pressure information by measuring the pressure of the battery case 110 by using the at least one pressure sensor 120 provided in the battery case 110. For example, the pressure sensor 120 may be provided on an outer wall of the battery case 110. As an example, the pressure sensor 120 may include, but is not limited to, a strain gauge-based pressure sensor attached to the outer wall of the battery case 110. Embodiments in which the pressure sensor 120 is provided at a certain location on the battery case 110 will be described later with reference to FIGS. 2 and 3, etc.

In embodiments, the pressure information may include pressure time series data collected from the pressure sensor 120. For example, the controller 140 may obtain pressure values in real time from the at least one pressure sensor 120 and generate pressure time series data by using the pressure values obtained so far.

In embodiments, the single battery case 110 may include a plurality of pressure sensors 120 attached to different locations, and in this case, the controller 140 may generate pressure time series data by using an average of pressure values obtained respectively from the plurality of pressure sensors 120.

Then, the controller 140 may determine whether the preset condition is satisfied, based on the pressure information. The preset condition indicates conditions for determining that there is a need to form a fluid discharge port in the battery case 110. That is, the controller 140 may generate pressure information by using the at least one pressure sensor 120 provided in the battery case 110 to determine whether the battery case 110 is in a state where formation of a fluid discharge port is required, and determine whether a preset condition is satisfied, based on the pressure information.

In embodiments, the preset condition may include conditions relating to at least one of various parameters associated with the battery cells and the battery case 110 accommodating the battery cells, such as pressure, time, temperature, current, and voltage. For example, the preset condition may include a momentary pressure exceeding a threshold pressure, or a pressure continuously exceeding a threshold pressure for a threshold period of time. Additionally, the preset condition may further include, in addition to the conditions described herein, exceeding of a threshold temperature by the temperature of the battery case 110 or overcurrent or overvoltage.

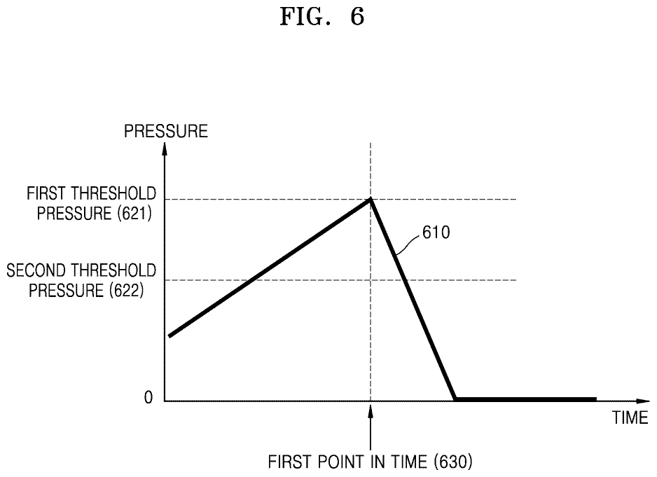

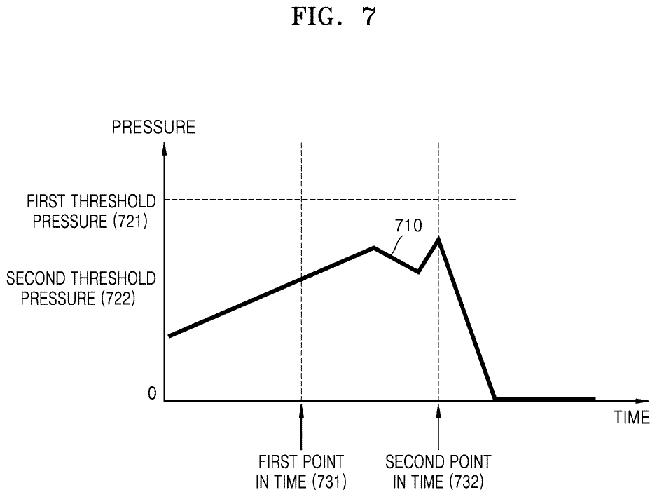

Examples of the preset conditions to determine the necessity of forming a fluid discharge port in the battery case 110 are described in detail later with reference to FIGS. 6 to 7, etc.

FIG. 2 is a diagram for describing a battery case and a pressure sensor, according to embodiments. FIG. 2 illustrates battery cases 111a, 111b, and 111c implemented as square cases and pressure sensors 121a, 121b, and 121c provided in the battery cases 111a, 111b, and 111c, respectively.

As described herein with reference to FIG. 1, the controller 140 may generate pressure information by measuring pressure of the battery cases 111a, 111b, and 111c by using the pressure sensors 121a, 121b, and 121c respectively provided in the battery cases 111a, 111b, 111c. In embodiments, the battery cases 111a, 111b, and 111c may be arranged in an x-axis direction.

For example, the controller 140 may generate pressure information corresponding to the first battery case 111a by measuring the pressure of the battery case 111a by using the at least one pressure sensor 121a provided in the first battery case 111a. Similarly, the controller 140 may generate pressure information corresponding to the second battery case 111b by measuring the pressure of the battery case 111b by using the at least one pressure sensor 121b provided in the second battery case 111b, and may generate pressure information corresponding to the third battery case 111c by measuring the pressure of the battery case 111c by using the at least one pressure sensor 121c provided in the third battery case 111c.

In embodiments, the pressure sensors 121a, 121b, and 121c provided in the battery cases 111a, 111b, and 111c may be provided between an inner wall 200 of a battery pack and the battery cases 111a, 111b, 111c and/or between the battery cases 111a, 111b, 111c and another battery case 111a, 111b, 111c adjacent thereto. The battery pack may have an internal space defined by the inner wall 200, and the inner wall 200 may surround the at least one of the battery cases 111a, 111b, 111c. FIG. 2 illustrates a portion of the inner wall 200 of a shape implemented in a flat form.

For example, the pressure sensor 121a provided in the first battery case 111a may be provided between the inner wall 200 of the battery pack and the first battery case 111a, as illustrated in FIG. 2. That is, the pressure sensor 121a provided in the first battery case 111a that comes into contact with the inner wall 200 in a positive x-axis direction may be provided on one surface of the first battery case 111a, the surface corresponding to the positive x-axis direction.

As another example, the pressure sensor 121a provided in the first battery case 111a may be provided between the second battery case 111b and the first battery case 111a, unlike FIG. 2. That is, the pressure sensor 121a provided in the first battery case 111a that comes into contact with the second battery case 111b in a negative x-axis direction may be provided in one surface of the first battery case 111a, the surface corresponding to the negative x-axis direction.

For another example, the pressure sensor 121a provided in the first battery case 111a may be provided both between the inner wall 200 of the battery pack and the first battery case 111a and between the second battery case 111b and the first battery case 111a. The controller 140 may generate pressure information corresponding to the first battery case 111a by using the average of pressure values collected from a plurality of pressure sensors 121a.

A partition wall may be formed between the inner wall 200 of the battery pack and the battery case 111a, 111b, or 111c and/or between the battery case 111a, 111b, or 111c and another adjacent battery case 111a, 111b, or 111c. For example, a partition wall may be formed between the first battery case 111a and the inner wall 200 of the battery pack and/or between the first battery case 111a and the second battery case 111b. The pressure sensor 121a provided in the first battery case 111a may be provided between the first battery case 111a and the partition wall. The partition wall between the first battery case 111a and the inner wall 200 of the battery pack may represent a partition wall extending from the inner wall 200 of the battery pack, and may represent a side wall of a battery module that accommodates a plurality of battery cells including the first battery case 111a and is accommodated in the battery pack.

FIG. 3 is a diagram for describing a battery case and a pressure sensor of embodiments. In FIG. 3, battery cases 112a, 112b implemented as cylindrical cases and pressure sensors 122a, 122b respectively provided in the battery cases 112a, 112b are illustrated. As described herein with reference to FIG. 1, the controller 140 may generate pressure information by measuring pressure of the battery cases 112a, 112b by using the pressure sensors 122a, 122b respectively provided in the battery case 112a, 112b. In embodiments, the battery cases 112a, 112b may be arranged in the x-axis direction.

For example, the controller 140 may generate pressure information corresponding to the first battery case 112a by measuring pressure of the battery case 112a by using at least one pressure sensor 122a provided in the first battery case 112a. Similarly, the controller 140 may generate pressure information corresponding to the second battery case 112b by measuring pressure of the battery case 112b by using at least one pressure sensor 122b provided in the second battery case 112b.

In embodiments, the at least one pressure sensor 122a, 122b provided in the battery case 112a, 112b may be provided between an inner wall of a battery pack and the battery case 112a, 112b and/or between the battery case 112a, 112b and another battery case 112a, 112b adjacent thereto.

For example, the pressure sensor 122a provided in the first battery case 112a may be provided between the inner wall of the battery pack and the first battery case 112a. That is, the pressure sensor 122a provided in the first battery case 112a that comes into contact with the inner wall in the positive x-axis direction may be provided in one surface of the first battery case 112a, the surface corresponding to the positive x-axis direction. For another example, the pressure sensor 122a provided in the first battery case 112a may be provided between the second battery case 112b and the first battery case 112a. That is, the pressure sensor 122a provided in the first battery case 112a that comes into contact with the second battery case 112b in the negative x-axis direction may be provided in one surface of the first battery case 112a, the surface corresponding to the negative x-axis direction.

As another example, the pressure sensor 122a provided in the first battery case 112a may be provided both between the inner wall of the battery pack and the first battery case 112a and between the second battery case 112b and the first battery case 112a. The controller 140 may generate pressure information corresponding to the first battery case 112a by using the average of pressure values collected from a plurality of pressure sensors 122a.

A partition wall may be formed between the inner wall of the battery pack and the battery case 112a, 112b and/or between the battery case 112a, 112b and another adjacent battery case 112a, 112b. For example, a partition wall may be formed between the first battery case 112a and the inner wall of the battery pack and/or between the first battery case 112a and the second battery case 112b. The pressure sensor 122a provided in the first battery case 112a may be provided between the first battery case 112a and the partition wall. The partition wall between the first battery case 112a and the inner wall of the battery pack may represent a partition wall extending from the inner wall of the battery pack, and may represent a side wall of a battery module that accommodates a plurality of battery cells including the first battery case 112a and is accommodated in the battery pack.

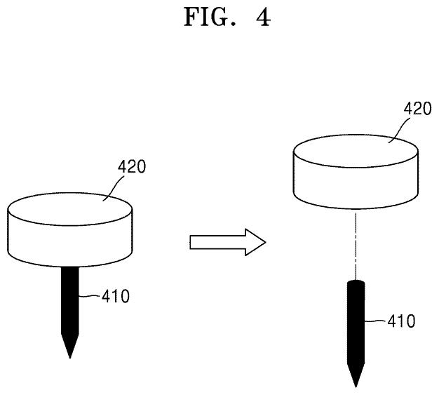

FIG. 4 is a diagram for describing a through unit according to embodiments.

Referring to FIG. 4, the through unit 130 may include a moving body 410 and a driving portion 420. In embodiments, the through unit 130 may include the moving body 410 penetrating the battery case 110 and the driving portion 420 moving the moving body 410 toward the battery case 110.

In embodiments, the moving body 410 may form a fluid discharge port at a predetermined location by penetrating a predetermined location on the battery case 110 where the fluid discharge port is not formed.

The shape, size, diameter and material of the moving body 410 according to an embodiment may be designed to easily penetrate the battery case 110 by considering the material, size, thickness and surface characteristics of the battery case 110. For example, a protrusion may be formed on the moving body 410 to protrude toward the battery case 110 to easily penetrate the battery case 110.

As an example, the moving body 410 may include a needle-shaped penetrator including a metal wire. For example, the needle-shaped penetrator may include a wire nail.

In embodiments, the driving portion 420 may provide driving force to the moving body 410 such that the moving body 410 moves toward the battery case 110. In embodiments, the driving portion 420 may, while being connected to the moving body 410, provide driving force to move the moving body 410 toward the battery case 110, or may, while being separated from the driving portion 420, provide driving force to move the moving body 410 toward the battery case 110.

For example, the driving portion 420 may include at least one of various components capable of providing driving force to the moving body 410, such as a driving motor, an actuator, a hydraulic device, or a pneumatic device, which is connected to the moving body 410 to apply force to the moving body 410.

Additionally, for example, the driving portion 420 may launch the moving body 410 toward the battery case 110 by using the explosion of gunpowder stored in the driving portion 420. The driving portion 420 may move the moving body 410 toward the battery case 110 by transferring the energy generated by the explosion of gunpowder, to the moving body 410 in a predetermined direction.

As an example, the driving portion 420 may include a pyrotechnic drive device having stored therein gunpowder.

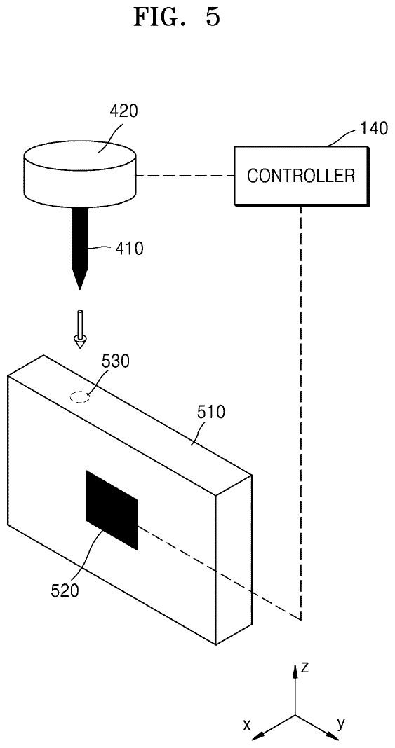

FIG. 5 is a diagram for describing a process of forming a fluid discharge port in a battery case, according to embodiments. Each of a battery case 510 and a pressure sensor 520 illustrated in FIG. 5 may correspond to the battery case 110 or the pressure sensor 120 illustrated in FIG. 1.

Referring to FIG. 5, the controller 140 may generate pressure information by measuring the pressure of the battery case 510 by using the pressure sensor 520, and determine whether a preset condition is satisfied, based on the pressure information.

Thereafter, the controller 140 may form a fluid discharge port 530 in the battery case 110 by controlling the through unit 130 based on a result of determining. For example, the controller 140 may control the through unit 130 to form the fluid discharge port 530 if it determines that a preset condition is satisfied.

In embodiments, the controller 140 may control the driving portion 420 of the through unit 130 to cause the driving portion 420 to move the moving body 410 toward the battery case 510. Thereafter, the fluid discharge port 530 may be generated by the moving body 410 penetrating a predetermined location on the battery case 510.

As described herein with reference to FIG. 4, the moving body 410 may, while being connected to the driving portion 420, move toward the battery case 510, and may, while being separated from the driving portion 420, also move toward the battery case 510 depending on the driving method.

In embodiments, the controller 140 may control the driving portion 420 to cause the moving body 410 to vertically penetrate one surface of the battery case 510 to form the fluid discharge port 530. For example, the controller 140 may control the driving portion 420 to cause the moving body 410 to move in a preset vertical direction. Thereafter, the fluid discharge port 530 may be formed on the battery case 510 by the moving body 410 penetrating a top cover of the battery case 510. For example, a preset vertical direction may represent the negative z-axis direction.

This allows fluid to be removed from the battery case 510 with increased internal pressure, preventing damage to the device and improving safety by removing the fluid before potential safety issues such as thermal runaway occur. Additionally, unnecessary damage to other side walls of the battery case 510 and other internal structures of the battery pack may be minimized.

Additionally, in embodiments, if the driving portion 420 is designed to launch the moving body 410 toward the battery case 110 by utilizing the explosion of the gunpowder stored therein, the controller 140 may control the driving portion 420 to explode the gunpowder stored therein, thereby causing the moving body 410 to penetrate the battery case 510, thereby forming the fluid discharge port 530.

Through this, in a situation where fluid discharge is required, it is possible to immediately form the fluid discharge port 530 by using the moving body 410 of a high speed, and the fluid discharge port 530 may be stably formed even in the battery case 510 with high internal pressure.

The controller 140 may transmit and receive signals by performing network communication with other components such as the pressure sensor 520 and the driving portion 420. The network is a comprehensive data communication network that allows different entities to communicate smoothly with each other, and may include various types of wired or wireless networks. The networks may include, but is not limited to, short-range networks such as Controller Area Network (CAN), Local Interconnect Network (LIN), FlexRay, Bluetooth, and Wi-Fi.

For example, the controller 140 may obtain a measured pressure value for the battery case 510 by performing communication with the pressure sensor 520 by using a network. Additionally, for example, the controller 140 may transmit a control command to the driving portion 420 by performing communication with the driving portion 420 via a network such that the driving portion 420 provides driving force to the moving body 410. As described herein with reference to FIG. 1, the preset condition according to embodiments may include conditions relating to at least one of pressure and time. Examples of the preset condition are described in detail herein with reference to FIGS. 6 to 7, etc.

FIGS. 6 and 7 are graphs for describing a preset condition according to embodiments.

In FIG. 6, a graph including pressure information of the battery case 510 expressed as first time series data 610 is illustrated.

Referring to FIG. 6, the preset condition may include at least one of a first condition in which the measured pressure exceeds a first threshold pressure 621 and a second condition in which the measured pressure exceeds a second threshold pressure 622 for a threshold period of time. For example, the preset condition may be set as the union of the first condition and the second condition.

The preset condition according to embodiments may include exceeding of the first threshold pressure 621 by the measured pressure. That is, when an instantaneous pressure measured for the battery case 510 exceeds the first threshold pressure 621, the controller 140 may immediately determine that the preset condition is satisfied.

For example, the controller 140 may determine that the preset condition is satisfied, when the pressure on the first time series data 610 exceeds the first threshold pressure 621 at a first point in time 630. Thereafter, the controller 140 may form the fluid discharge port 530 on the battery case 510 by controlling the driving portion 420. Accordingly, the fluid inside the battery case 510 may be discharged, and the pressure on the first time series data 610 may decrease after the first point in time 630.

That is, if the pressure inside the battery case 510 momentarily exceeds the first threshold pressure 621, even if the pressure inside the battery case 510 does not exceed the second threshold pressure 622 for the threshold period of time, a risk of an accident due to the momentary pressure increase may occur.

According to embodiments, when the pressure inside the battery case 510 momentarily exceeds the first threshold pressure 621, a fluid discharge port is formed in the battery case 510 immediately, thereby removing the fluid from the battery case 510 before an accident occurs, thereby minimizing damage from the accident.

In FIG. 7, a graph including pressure information of the battery case 510 expressed as second time series data 710 is illustrated.

Referring to FIG. 7, the preset condition may include at least one of a first condition in which the measured pressure exceeds a first threshold pressure 721 and a second condition in which the measured pressure exceeds a second threshold pressure 722 for the threshold period of time. For example, the preset condition may be set as the union of the first condition and the second condition.

The preset condition according to embodiments may include exceeding of the second threshold pressure 722 by the measured pressure for the threshold period of time. The threshold period of time is illustrated in FIG. 7 as a difference between a first point in time 731 and a second point in time 732 representing the threshold period of time.

For example, if the pressure measured for the battery case 510 continuously exceeds the second threshold pressure 722 for the threshold period of time, the controller 140 may determine that the preset condition is satisfied, even if the instantaneous pressure measured for the battery case 510 does not exceed the first threshold pressure 721.

For example, the controller 140 may determine that the preset condition is satisfied at the second point in time 732 when the pressure on the second time series data 710 exceeds the second threshold pressure 722 at the first point in time 731 and the pressure on the second time series data 710 exceeds the second threshold pressure 722 and is lower than the first threshold pressure 721 until the second point in time 732.

Thereafter, the controller 140 may form the fluid discharge port 530 on the battery case 510 by controlling the driving portion 420. Accordingly, the fluid inside the battery case 510 may be discharged, and the pressure on the second time series data 710 may decrease after the second point in time 732.

That is, if the pressure inside the battery case 510 exceeds the second threshold pressure 722 and continues for the threshold period of time, even if the pressure inside the battery case 510 does not exceed the first threshold pressure 721, there is a risk of an accident due to the high internal pressure continuing for a long period of time.

According to embodiments, if the pressure inside the battery case 510 exceeds the second threshold pressure 722 for the threshold period of time, a fluid discharge port is formed in the battery case 510 to remove the fluid from the battery case 510 before an accident occurs, thereby minimizing damage from the accident.

With reference to FIGS. 6 and 7, at least one of the first threshold pressures 621 and 721, the threshold period of time, and the second threshold pressure 622 and 722 described herein may be set based on the usage status of a battery cell corresponding to the battery case 510. The usage status of the battery cell may include the usage period of the battery cell, the number of charge/discharge cycles, and state of health (SOH).

For example, the longer the battery cell's lifespan or the longer the number of charge/discharge cycles, or the lower its SOH, the greater the potential accident risk of the battery cell. Conversely, the shorter the battery cell's lifespan or the shorter the number of charge/discharge cycles, or the higher its SOH, the smaller the potential risk of a battery cell accident.

In embodiments, as the usage period of a certain battery cell increases or the number of charge/discharge cycles increases, at least one of the first threshold pressures 621, 721, the threshold period of time, and the second threshold pressures 622, 722 for the battery case 510 accommodating the certain battery cell may decrease. Additionally, as the SOH for a certain battery cell decreases, at least one of the first threshold pressures 621 and 721, the threshold period of time, and the second threshold pressures 622, 722 for the battery case 510 accommodating the certain battery cell may decrease.

Through this, the problem of the vent not reflecting the usage status of the battery cell may be addressed by dynamically adjusting the conditions for forming a fluid discharge port in the battery case 510 according to the usage status of the battery cell.

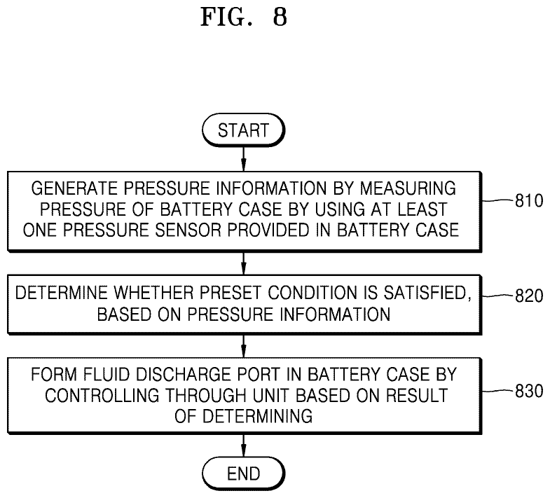

FIG. 8 is an example of an operating method of a fluid removing apparatus, according to embodiments.

Referring to FIG. 8, in operation 810, the controller 140 may generate pressure information by measuring pressure of a battery case by using at least one pressure sensor provided in the battery case.

In embodiments, the battery case may accommodate any one of a plurality of battery cells forming a battery pack. At least one pressure sensor may include at least one of a pressure sensor provided between an inner wall of the battery pack and a battery case and a pressure sensor provided between the battery case and another battery case adjacent to the battery case.

In operation 820, the controller 140 may determine whether a preset condition is satisfied, based on the pressure information.

In embodiments, the preset condition may include conditions relating to at least one of pressure and time.

For example, the preset condition may include at least one of a first condition in which the measured pressure exceeds a first threshold pressure and a second condition in which the measured pressure exceeds a second threshold pressure for a threshold period of time.

At least one of the first threshold pressure, the threshold period of time, and the second threshold pressure may be set based on the usage status of a battery cell corresponding to the battery case.

In operation 830, the controller 140 may form a fluid discharge port in the battery case by controlling a through unit based on a result of the determining.

In embodiments, the through unit may include a moving body that penetrates the battery case and a driving portion that moves the moving body toward the battery case. The controller 140 may form a fluid discharge port by controlling the driving portion to cause the moving body to vertically penetrate one side of the battery case.

In embodiments, the driving portion may be configured to launch the moving body toward the battery case by using an explosion of gunpowder stored in the driving portion. The controller 140 may control the driving portion to explode the gunpowder, thereby forming a fluid discharge port by causing the moving body to penetrate the battery case.

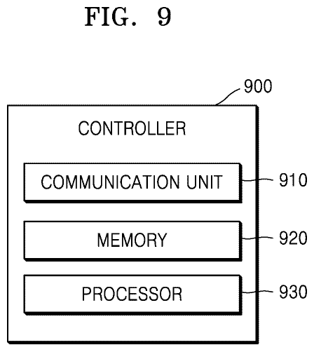

FIG. 9 is a block diagram of a controller according to embodiments. A controller 900 illustrated in FIG. 9 may correspond to the controller 140 illustrated in FIG. 1.

Referring to FIG. 9, the controller 900 may include a communication unit 910, a memory 920, and a processor 930. Only components associated with the embodiment are shown in the controller 900 of FIG. 9. Accordingly, it will be understood by those skilled in the art that the controller 900 may further include other general components in addition to the components illustrated in FIG. 9.

The communication unit 910 may include at least one component that allows the controller 900 to perform wired/wireless communication with another device. For example, the communication unit 910 may include a wired communication unit for implementing Ethernet, serial communication, or optical communication, and/or a wireless communication unit for implementing Wi-Fi, Bluetooth, or cellular network-based communication.

The memory 920 is a hardware that stores various data processed within the controller 900, and may store programs for various operations, processing, and control of the processor 930.

The memory 920 may include random access memory (RAM) such as dynamic random-access memory (DRAM), static random-access memory (SRAM), read-only memory (ROM), electrically erasable programmable read-only memory (EEPROM), compact disc (CD)-ROM, Blu-ray or other optical disk storage, hard disk drive (HDD), solid state drive (SSD), or flash memory.

The processor 930 controls the overall operation of the controller 900. For example, the processor 930 may control the communication unit 910, the memory 920, an input unit (not shown), and/or an output unit (not shown) in general by executing programs stored in the memory 920. The processor 930 may control the operation of the controller 900 by executing at least one program stored in the memory 920.

The processor 930 may control at least some of the operations of the controller 900 described herein with reference to FIGS. 1 to 8. For example, the processor 930 may generate pressure information by measuring pressure of a battery case by using at least one pressure sensor provided in the battery case, determine whether a preset condition is satisfied, based on the pressure information, and control a through unit based on a result of the determination, thereby allowing the fluid removing apparatus 100 to form a fluid discharge port in the battery case.

A specific example of how the processor 930 operates is the same as described herein with reference to FIGS. 1 to 8. Thus, a detailed description of the operation of the processor 930 is omitted herein.

The processor 930 may be implemented using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors, and other electrical units for performing functions.

Embodiments according to the present disclosure may be implemented in the form of a computer program that can be executed through various components on a computer, and such a computer program may be recorded on a computer-readable medium. The medium may include, but is not limited to, magnetic media such as hard disks, floppy disks, and magnetic tapes, optical recording media such as CD-ROMs and digital versatile discs (DVDs), magneto-optical media such as floptical disks, and hardware devices specifically configured to store and execute program instructions, such as ROMs, RAMs, flash memory, and the like.

The computer program may be specially designed and configured for the present disclosure or may be known and available to those skilled in the art in the computer software field. Examples of computer programs may include not only machine language code, such as that produced by a compiler, but also high-level language code that can be executed by a computer using an interpreter or the like.

According to embodiments, a method according to various embodiments of the present disclosure may be provided as included in a computer program product. Computer program products may be traded between sellers and buyers as commodities. The computer program product may be distributed in the form of a machine-readable storage medium (e.g., compact disc read only memory (CD-ROM)), or may be distributed online (e.g., by download or upload), via an application store (e.g., Play Store™), or directly between two user devices. In the case of online distribution, at least a portion of the computer program product may be temporarily stored or temporarily created in a machine-readable storage medium, such as the memory of a manufacturer's server, an application store's server, or an intermediary server.

Unless there is an explicit description or contradiction of the order of steps constituting the method according to the present disclosure, the steps may be performed in any suitable order. The present disclosure is not necessarily limited to the order in which the above steps are described. The use of any and all examples, or exemplary language (e.g., “such as”) provided herein, is intended merely to better illuminate the present disclosure and does not pose a limitation on the scope of the present disclosure unless otherwise claimed. Numerous modifications and adaptations will be readily apparent to those skilled in this art without departing from the spirit and scope of the present disclosure.

Thus, the present disclosure should not be limited to the embodiments described herein, and not only the scope of the patent claims described herein, but also all scopes equivalent to or equivalently modified from the scope of the patent claims are included in the scope of the present disclosure.

According to the present disclosure described herein, by using a through unit that forms a fluid discharge port under the control by a controller, fluid discharge may be ensured when discharge of a fluid from a case is required.

The effects of the embodiments of the present disclosure are not limited to the effects described herein, and other effects not described herein will be clearly understood by those skilled in the art from the description of the present specification.

What is claimed is:

1. A method of removing a fluid from a battery case, the method comprising:
generating pressure information by measuring a pressure of the battery case by using at least one pressure sensor provided in the battery case;
determining whether a preset condition is satisfied, based on the pressure information; and
forming a fluid discharge port in the battery case by controlling a through unit based on a result of the determining.

2. The method of claim 1, wherein the preset condition comprises a condition associated with at least one of pressure and time.

3. The method of claim 2, wherein the preset condition comprises at least one of a first condition in which the measured pressure exceeds a first threshold pressure and a second condition in which the measured pressure exceeds a second threshold pressure for a threshold period of time.

4. The method of claim 3, wherein at least one of the first threshold pressure, the threshold period of time, and the second threshold pressure is set based on a usage state of a battery cell corresponding to the battery case.

5. The method of claim 1, wherein the battery case accommodates any one of a plurality of battery cells forming a battery pack, and
the at least one pressure sensor comprises at least one of a pressure sensor provided between an inner wall of the battery pack and the battery case and a pressure sensor provided between the battery case and another adjacent battery case.

6. The method of claim 1, wherein the through unit comprises a moving body penetrating the battery case and a driving portion moving the moving body toward the battery case.

7. The method of claim 6, wherein the forming of the fluid discharge port comprises forming the fluid discharge port by controlling the driving portion to cause the moving body to vertically penetrate one surface of the battery case.

8. The method of claim 7, wherein the driving portion launches the moving body toward the battery case by using explosion of gunpowder stored in the driving portion.

9. The method of claim 8, wherein the forming of the fluid discharge port comprises forming the fluid discharge port by controlling the driving portion to explode the stored gunpowder such that the moving body penetrates the battery case.

10. A fluid removing apparatus for removing a fluid, the fluid removing apparatus comprising:
a battery case accommodating a battery cell;
a through unit forming a fluid discharge port in the battery case; and
a controller controlling the through unit, wherein the controller is configured to:
generate pressure information by measuring a pressure of the battery case by using at least one pressure sensor provided in the battery case,
determine whether a preset condition is satisfied, based on the pressure information, and
form a fluid discharge port in the battery case by controlling the through unit based on a result of the determining.

11. The fluid removing apparatus of claim 10, wherein the preset condition comprises a condition associated with at least one of pressure and time.

12. The fluid removing apparatus of claim 11, wherein the preset condition comprises at least one of a first condition in which the measured pressure exceeds a first threshold pressure and a second condition in which the measured pressure exceeds a second threshold pressure for a threshold period of time.

13. The fluid removing apparatus of claim 12, wherein at least one of the first threshold pressure, the threshold period of time, and the second threshold pressure is set based on a usage state of a battery cell corresponding to the battery case.

14. The fluid removing apparatus of claim 10, wherein the battery case accommodates any one of a plurality of battery cells forming a battery pack, and
the at least one pressure sensor comprises at least one of a pressure sensor provided between an inner wall of the battery pack and the battery case and a pressure sensor provided between the battery case and another adjacent battery case.

15. The fluid removing apparatus of claim 10, wherein the through unit comprises a moving body penetrating the battery case and a driving portion moving the moving body toward the battery case.

16. The fluid removing apparatus of claim 15, wherein the forming of the fluid discharge port comprises forming the fluid discharge port by controlling the driving portion to cause the moving body to vertically penetrate one surface of the battery case.

17. The fluid removing apparatus of claim 16, wherein the driving portion launches the moving body toward the battery case by using explosion of gunpowder stored in the driving portion.

18. The fluid removing apparatus of claim 17, wherein the forming of the fluid discharge port comprises forming the fluid discharge port by controlling the driving portion to explode the stored gunpowder such that the moving body penetrates the battery case.

19. A computer-readable recording medium having recorded thereon a program for causing a computer to execute the method according to claim 1.
